(19) United States
(12) Patent Application Publication
(10) Pub. No.: US 2021/0359744 A1
(43) Pub. Date: Nov. 18, 2021

(54) MOBILE NETWORK ARCHITECTURE AND METHOD OF USE THEREOF

(71) Applicant: ATR Electronics, LLC, San Antonio, TX (US)

(72) Inventors: Ralph E. Hayles, JR., San Antonio, TX (US); David H. Hitt, Plano, TX (US)

(21) Appl. No.: 17/321,262

(22) Filed: May 14, 2021

Related U.S. Application Data
(60) Provisional application No. 63/024,871, filed on May 14, 2020.

(51) Int. Cl. H04B 7/06; H04B 7/0408; H01Q 5/40; H01Q 3/46

(52) U.S. Cl. CPC H04B 7/0686; H01Q 3/46; H01Q 5/40; H04B 7/0408

(57) ABSTRACT

The disclosure provides a wireless communications systems that uses a polybeam geometry. A polybeam communications network, a polybeam antenna, a method of communicating are disclosed. In one example, the polybeam communications network includes: (1) a first communications structure, (2) first transceivers, and (3) a first polybeam antenna attached to the first communications structure that transmits first communication beams driven by corresponding ones of the first transceivers, having arcs of less than twenty degrees each and defining overlapping territories of coverage.

### CROSS-REFERENCE TO RELATED APPLICATION

This application claims the benefit of U.S. Provisional Application Ser. No. 63/024,871, filed by Hayles, et al. on May 14, 2020, entitled “MOBILE NETWORK ARCHITECTURE AND METHOD OF USE THEREOF,” commonly assigned with this application and incorporated herein by reference in its entirety.

### TECHNICAL FIELD

This application is directed, in general, to wireless communications and, more specifically, to a geometry of wireless communication systems.

### BACKGROUND

Wireless communications systems are a vital technology in today's world. Cell phone towers are installed throughout the world to provide a network for wireless communication. Most signals emitting from cell towers today are usually shaped into 30, 40, or 60 degree sub-sectors of 120 degree sectors to provide full 360 degree coverage around the cell towers. A single tower can support two or more operators and multiple carriers, with each entity employing their own varying antenna arrays (including panel, sector, and other antennas) mounted on platforms that orient the antennas for sector coverage.

Cell tower and cellular network evolution has been effective to provide coverage and a key to success of the information age and personal communications via smartphones, tablets, and other communication devices over the last fifty years. The demand for more wireless bandwidth, however, continues to increase with the rollout of 5G technology and the bandwidth needed to support video content so enjoyed by the mobile consumers. Some providers are rolling out millimeter wave (mmW) wireless service with short range coverage to provide high data service in conventional cellular networks. The infrastructure costs and physical intrusions to provide this mmW urban coverage can be significant, and quickly become unaffordable in rural areas due to the sparsity of customers. New C-Band and higher Ku-Band solutions are needed to provide rural and urban areas with more affordable 5G signals that provide high speed service and also combine with mmW service to further increase customer data rates.

### SUMMARY

In one aspect the disclosure provides a polybeam communications network. In one example, the polybeam communications network includes: (1) a first communications structure, (2) first transceivers, and (3) a first polybeam antenna attached to the first communications structure that transmits first communication beams driven by corresponding ones of the first transceivers, having arcs of less than twenty degrees each and defining overlapping territories of coverage.

In another aspect, the disclosure provides a polybeam antenna. In one example, the polybeam antenna includes: (1) a lens and (2) a polybeam feed network of signal conveyors aligned with the lens to transmit radio frequency signals via one or more communication beams, wherein each one of the one or more communication beams has an arc of less than twenty degrees and define overlapping territories of coverage.

In yet another aspect, the disclosure provides a method of communicating using a polybeam communications network. In one example, the method includes: (1) capturing radio frequency signals from a communication device via one of multiple communication beams, wherein each of the multiple communication beams has an arc of less than twenty degrees, (2) providing the captured radio frequency signals to radio equipment, and (3) transmitting radio frequency signals received from the radio equipment to the communication device via one of the multiple communication beams.

### BRIEF DESCRIPTION

Reference is now made to the following descriptions taken in conjunction with the accompanying drawings, in which:

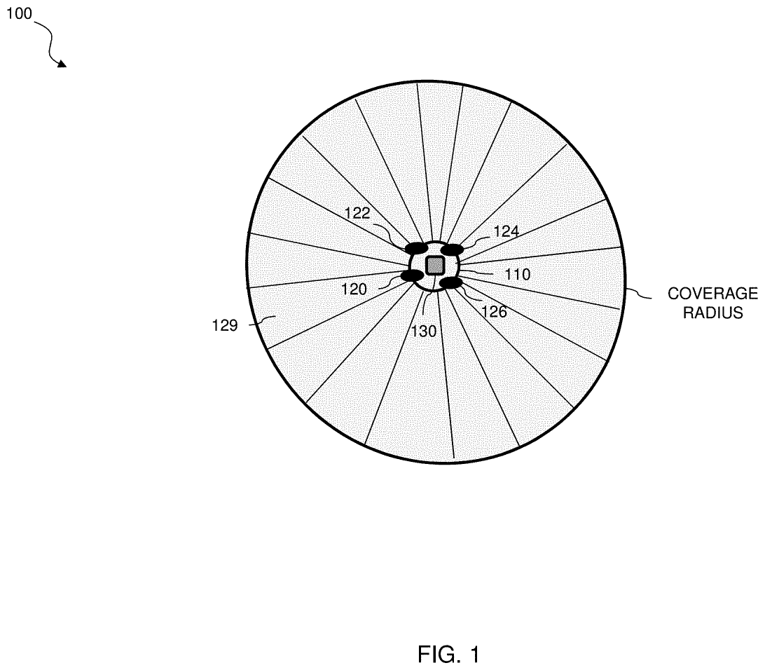

FIG. 1 illustrates a diagram of an example of a polybeam communications network constructed according to the principles of the disclosure;

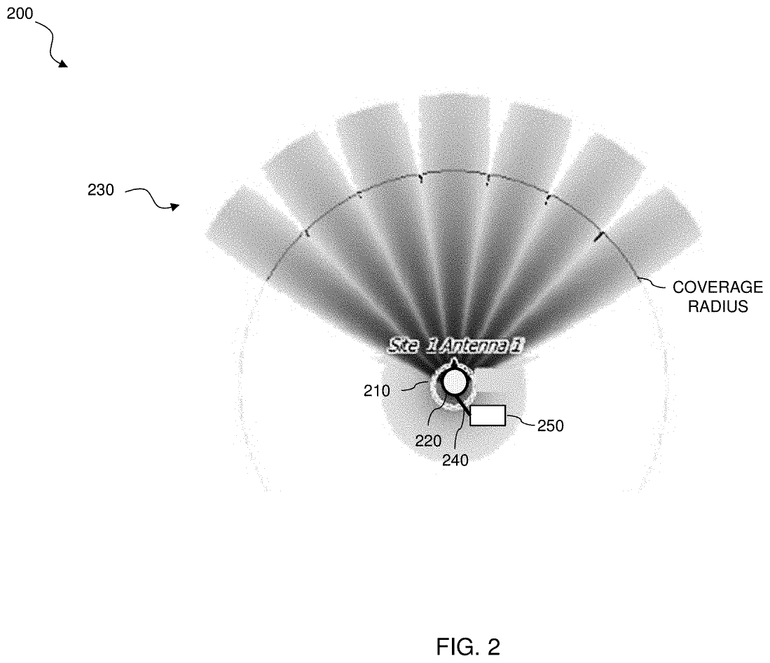

FIG. 2 illustrates a radiation diagram of an example of a polybeam communications network providing 120 degrees of coverage according to the principles of the disclosure;

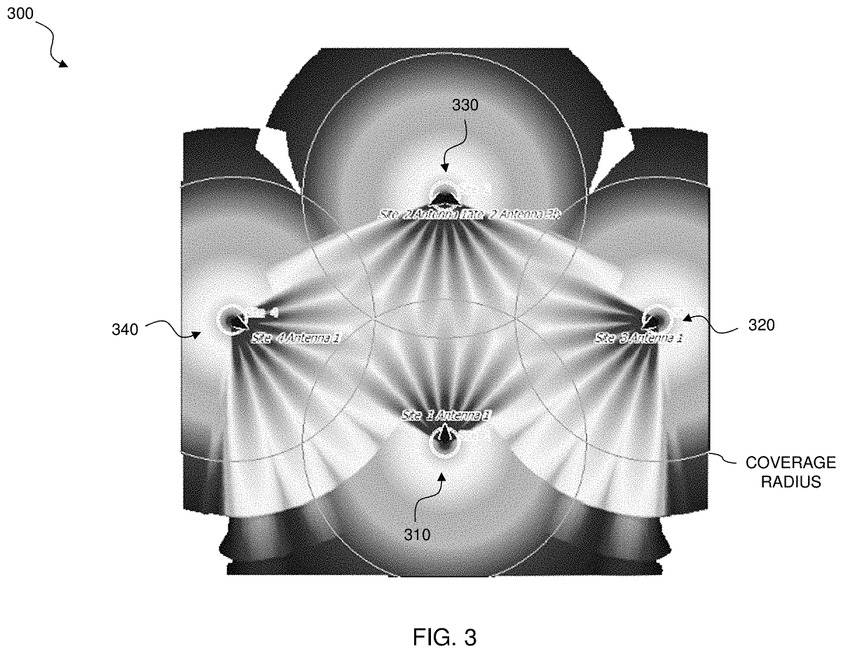

FIG. 3 illustrates a radiation diagram of another example of a polybeam communications network constructed according to the principles of the disclosure;

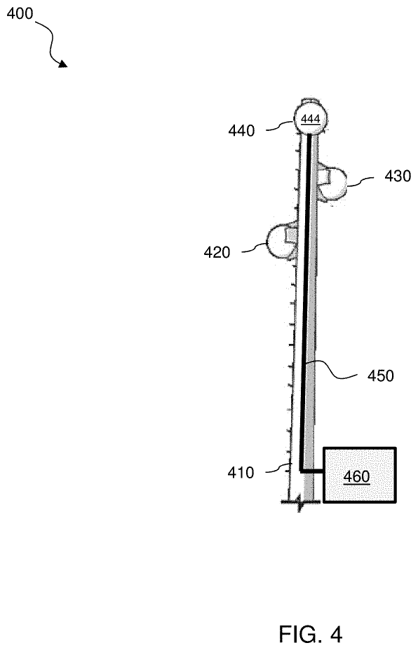

FIG. 4 illustrates a diagram of an example of a communications structure having polybeam antennas constructed according to the principles of the disclosure;

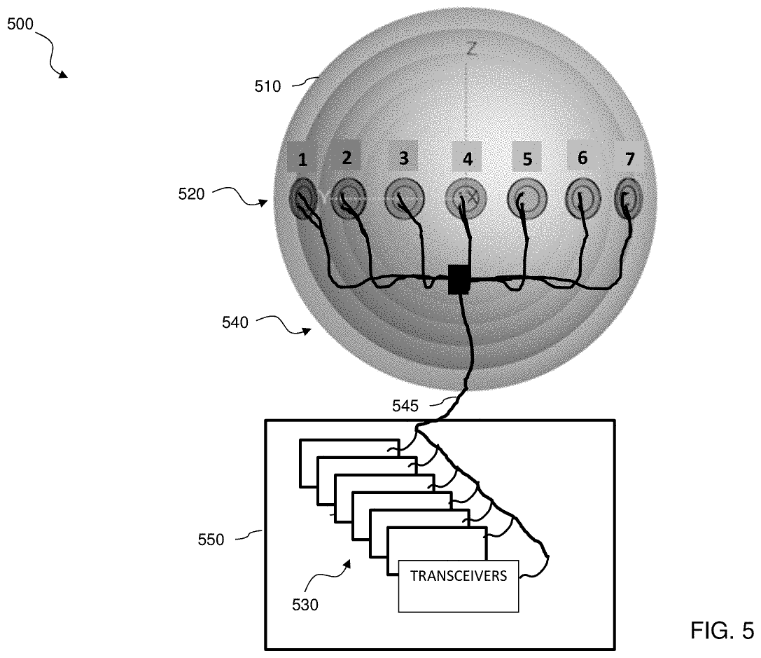

FIG. 5 illustrates a diagram of an example of a polybeam antenna constructed according to the principles of the disclosure;

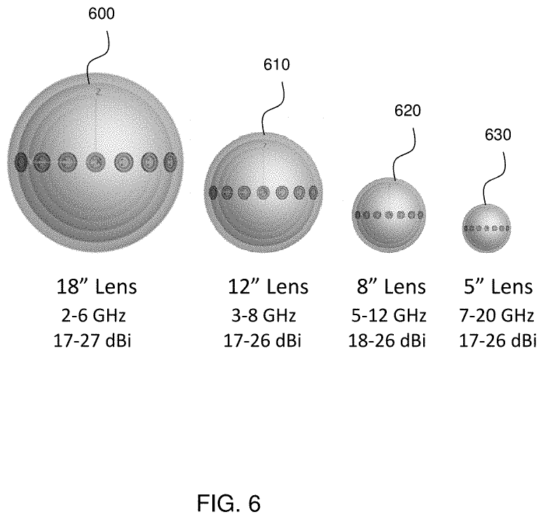

FIG. 6 illustrates examples of various Luneburg lenses that can be used in polybeam antennas according to the principles of the disclosure; and

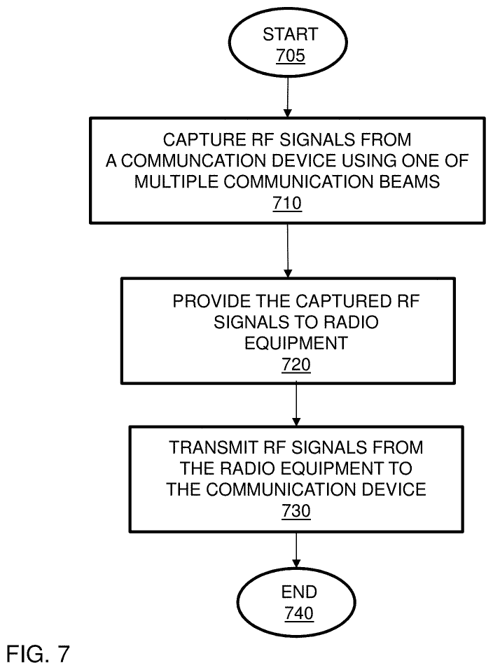

FIG. 7 illustrates a flow diagram of an example of a method of communicating carried out according to the principles of the disclosure.

### DETAILED DESCRIPTION

With current cellular networks, the need for higher data rates requires higher frequencies for transmission. Additionally, improved battery life is also desired for communication devices, which requires lower transmit power, resulting in smaller cells, resulting in more towers. Instead of adjusting and manipulating conventional cellular networks to meet existing and future wireless communication demand and desires, the disclosure recognizes that an improved wireless geometry is needed.

Accordingly, the disclosure provides a wireless communication system resulting from many, relatively narrow beams emanating from each communication structure, i.e. a polybeam geometry. The narrow beams emanating from the communication structures are radial beams that are referred to herein as communication beams. The polybeam geometry uses powerful polybeam antennas that are compact devices, which can be easily mounted onto existing cell towers and connected to existing carrier radios and backhaul circuitry. In addition to using existing structures, the polybeam antennas can also be mounted in new locations to provide additional coverage areas.

A polybeam antenna is a lens through which passes beams from multiple feeds. The multiple feeds can be provided from radio frequency transceivers, or simply transceivers, via signal conveyors that are aligned with the lens to transmit radio frequency signals within a defined area. Each one of the multiple feeds cooperates with the lens to provide a distinct communication beam within a defined area. The number of the communication beams transmitted by a polybeam antenna can be determined by the number of feeds provided to the lens. The signal conveyors are connected to the transceivers, which can be located, for example, at the base of a communication structure supporting the polybeam antenna. The number of feeds and the diameter of the lens can vary according to, for example, the desired number of communication beams and the desired frequency used for transmitting the communication beams. The lens can be a Luneburg lens or another type of Gradient-Index (GRIN) lens. A Luneburg lens is used herein in various examples. The signal conveyors can form a polybeam feed network. As disclosed herein, the signal conveyors can be patch antennas.

Though compact in size, the polybeam antennas transmit powerful, focused communication beams that can increase coverage area, provide increased bandwidth in a coverage area by utilizing more beams, and potentially reduce cost per coverage area compared to current cellular technology. For example, the bandwidth can be increased by five to ten times and the reduction in cost can be up to forty percent. Additionally, higher data rates are provisioned, better battery life is passed on to customer mobile devices, and lower transmit power is needed at both ends of the communication link.

FIG. 1 illustrates a diagram of an example of a polybeam communications network 100 constructed according to the principles of the disclosure. FIG. 1 provides a simple, overview of the polybeam communications network 100 showing the polybeam geometry that uses communication beams to provide a coverage area for wireless communications. The polybeam communications network 100 includes a communications structure 110, polybeam antennas 120, 122, 124, 126, and a local antenna 130. The polybeam antennas 120, 122, 124, 126, transmit communication beams 129 that provide a coverage area of 360 degrees around the communications structure 110 and that emanate from the communications structure 110 to at least a coverage radius. A coverage radius represents a distance corresponding to an emanating communication beam that can be used for configuring a polybeam communications network. The coverage radius can be used as a design factor, for example, to determine placement of antenna sites, alignment of communication beams, and interleaving of the communication beams. A coverage radius can vary for different polybeam antennas and can be used to select the polybeam antennas needed to provide desired coverage in a polybeam communications network. A communication beam can emanate beyond its coverage radius, such as shown in FIGS. 2 and 3. The polybeam communications network 100 can include additional components, such as radio equipment, that are not illustrated in FIG. 1. FIGS. 4 and 5 provide examples of polybeam antennas mounted on a communications structure and a polybeam antenna that can be used by the polybeam communications network 100 to provide the communication beams 125.

The communications structure 110 provides support for mounting the polybeam antennas 120, 122, 124, 126, that provide the communication beams 129. The communications structure 110 can be a tower that is used to provide an elevation of the polybeam antennas 120, 122, 124, 126, compared to the proximate terrain. The communications structure 110 can also be another type of support or structure positioned at various locations, including a building (side or roof), a silo, a steeple, an aviation platform, a water tower, or another type of elevated structure. Cabling can be mounted on the communications structure 110 to couple the polybeam antennas 120, 122, 124, 126, to transceivers. The transceivers can be located with electronic circuitry and/or other radio equipment at the base of the communications structure 110, such as shown in FIG. 4.

The communications beams 129 are transmitted by the polybeam antennas 120, 122, 124, 126, and are driven by corresponding ones of the transceivers. Each of the communication beams 129 has an arc of less than twenty degrees. Nineteen individual communication beams 129 are illustrated in FIG. 1 as an example. More communication beams 129 can be used to provide the 360 degrees of coverage. For example seven communication beams can be used for each 120 degrees of coverage as illustrated in FIG. 2.

As illustrated in FIG. 1, four polybeam antennas 120, 122, 124, 126, are used to provide the communication beams 129. In some examples, three polybeam antennas can be used to provide communication beams for 360 degrees of coverage. Two or more of the polybeam antennas 120, 122, 124, 126, can provide a same number of the communication beams 129. In other examples, each of the polybeam antennas 120, 122, 124, 126, can provide a different number of the communication beams 129.

In addition to an arc of less than twenty degrees, each of the communication beams 129 define overlapping territories of coverage. To reduce complexity, the overlapping territories of the communication beams 129 are not shown in FIG. 1. Examples of the overlapping territories of communication beams can be seen in FIGS. 2 and 3.

The local antenna 130 is attached to the communications structure 110 and provides wireless coverage proximate to the communications structure 110 to prevent, for example, multiple hand-offs between the communication beams 129 when a communication device is moving axially around the communication structure 110. The local antenna 130 can be an omnidirectional antenna that provides 360 degrees of coverage with respect to the communications structure 110. Other types of antennas that define a territory of coverage having an arc of different degrees can also be used to provide proximate coverage around the communications structure 110. In other examples, one or more local antenna can be used that defines a territory of coverage having an arc of at least 60 degrees. Radio equipment can control and coordinate hand-offs between the communication beams 129 of the polybeam antennas 120, 122, 124, 126, and with the local antenna 130. One or more processors can be directed by algorithms to control the hand-off procedures for various communicating devices moving within the coverage area of the polybeam antennas 120, 122, 124, 126, and the local antenna 130. Conventional switching procedures can be used to control the hand-offs.

FIG. 2 illustrates a radiation diagram of an example of a polybeam communications network 200 providing 120 degrees of coverage according to the principles of the disclosure. As in FIG. 1, the polybeam communications network 200 illustrates a single polybeam antenna site having a single communications structure 210. In contrast to the polybeam communications network 100, the polybeam communications network 200 provides a coverage area of 120 degrees with a single polybeam antenna 220. The polybeam antenna 220 includes a lens and a polybeam feed network (which are not illustrated) that cooperate with transceivers to transmit communication beams 230. The polybeam feed network includes signal conveyors connected via cabling 240 to transceivers located at radio equipment 250.

One skilled in the art will understand that the number of communication beams, beam widths, and effective signal transmit/receive distances will vary with lens diameter, frequency, and power. In this example, the lens is an 18 inch spherical Luneburg lens connected to seven signal conveyors of a polybeam feed network that creates the seven communication beams 230 to provide a coverage area of 120 degrees when connected to transceivers at the radio equipment 250. Each of the communications beam has an arc of 17.2 degrees and covers a slice of the 120 degree coverage area. Beam width dimensions of the communication beams 230 continue to widen past the coverage radius. In this example, each of the communication beams 230 has a beam width of 6.12 miles wide at the coverage radius of 20 miles. The width of the communication beams 230 is at 3.06 miles wide at a radius of 10-miles and 1.53 miles wide at a radius of 5-miles.

The strength of each of the communication beams 230 varies according to directional antenna properties. In FIG. 2, the darker portion of the communication beams 230 represent a stronger signal and the lighter portions of the communication beams 230 represent a signal with less strength. For example, the darker portion corresponds to 4-bar signal strength on an iPhone 12, and the lighter areas around the 4-bar signals represent 3-bar signals on an iPhone 12. The communication beams 230 provide radial coverage that extends beyond the coverage radius and includes about 15-miles of 4-bar signal strength on an iPhone 12, and approaching 26-miles of 3-bar signal strength on the iPhone 12. These impressive signal strengths and extended communication distances can be utilized to provide a new polybeam geometry for both urban areas and also for rural customer coverage.

FIGS. 1 and 2 illustrate polybeam communication networks that include a single antenna site. As illustrated in FIG. 3, a polybeam communications network can have more than one antenna site and at least some of the communication beams from the different antenna sites can be interleaved to fill in the void areas that begin appearing proximate the coverage radius, which is 20 miles in FIG. 2 and also in FIG. 3.

FIG. 3 illustrates a radiation diagram of an example of a polybeam communications network 300 constructed according to the principles of the disclosure. The polybeam communications network 300 includes four antenna sites 310, 320, 330, and 340, that each provide 120 degrees of coverage. Each of the antenna sites 310, 320, 330, and 340, can be the antenna site of FIG. 2, which has seven communication beams per 120 degrees. As noted above, the alignment of at least some of the communication beams from each of the antenna sites 310, 320, 330, and 340, is rotated such that some of the territories of coverage of the communication beams from the different antenna sites 310, 320, 330, 340, are interleaved.

The interleaved communication beams fill in void areas or low signal areas between beams by mixing and switching between two or more radio signals to provide stronger wireless cover at the periphery of the communication beams, such as beyond the coverage radius. The coverage radius for antenna site 320 is specifically denoted in FIG. 3. Interleaved communication beams increase signal strength to customers and increase area coverage per antenna site. Interleaving of the communication beams can be performed at installation, such as when one or more antenna site is added or a polybeam antenna is added to an existing antenna site. For example, antenna site 330 may be added after antenna site 310 has been installed. The centers of each of the seven communication beams emanating from antenna site 310 are separated by approximately 17 degrees, 17.2 degrees. When antenna site 330 is installed, the polybeam antenna of antenna site 330 can be rotated by half the center beam separation relative to antenna site 310, which is about 8.5 degrees. For another example, if there are eight communication beams per 120 degrees, then the relative rotation would be 7.5 degrees. Similar rotational adjustments can also be performed for interleaving when installing antenna sites 320 and 340. The exact amount of rotation for interleaving can also be adjusted based on signal strength testing during installation or maintenance at a later date.

In addition to interleaving of communication beams, additional antenna sites can be added to supplement the coverage of the communication beams emanating from one or more of the antenna sites 310, 320, 330, 340. One or more additional antenna sites can be added to provide supplemental coverage in areas where the terrain, buildings, or other natural or man-made features affect communication of radio frequency signals via the communication beams. These supplemental antenna sites can include one or polybeam antenna, one or more of another type of antenna, such as an omnidirectional antenna, or a combination thereof.

FIG. 4 illustrates a diagram of an example of a polybeam antenna site 400 constructed according to the principles of the disclosure. The polybeam antenna site 400 includes a communication structure 410 and three polybeam antennas 420 430, 440, that cooperate to provide 360 degrees of coverage. For example, each of the polybeam antennas 420 430, 440, can provide 120 degrees of coverages. Each of the polybeam antennas 420 430, 440 can also communicate radio frequency signals for multiple carriers within their coverage area. The polybeam antenna site 400 can replace or complement the radio frequency functions of conventional cell towers, including communicating radio frequency signals that bear voice and data. Additionally, each of the polybeam antennas 420 430, 440, can communicate radio frequency signals within their coverage area over multiple bands for each of the carriers, such as a high band and a low band. Using a polybeam antenna having a Luneburg lens with an 18 inch diameter as an example, the high band can be between approximately 3700 to 4200 MHz and the low band can be between approximately 1700 to 2600 MHz.

The antenna site 400 includes cabling 450 that couples the polybeam antennas 420 430, 440 to radio equipment 460. More specifically, the cabling 450 couples the signal conveyors of the polybeam feed networks of each of the polybeam antennas 420 430, 440, to transceivers located in the radio equipment 460. The radio equipment 460 can be housed in a structure at the base of the communications structure 410 that also includes other components such as power supplies and connections to the Public Switched Telephone Network (PSTN).

The communications structure 410 is constructed of a sufficient strength to support the polybeam antennas 420 430, 440, and have a sufficient height to position the three polybeam antennas 420 430, 440, at an elevation for wireless communications. As such, the height of the communication structure 410 can vary depending on installation site. As shown in FIG. 4, the elevation of the different polybeam antennas 420 430, 440, can also vary. In other antenna sites, multiple polybeam antennas can be positioned at the same elevation. In FIG. 4, the communication structure 410 is a pole but other structures or supports, such as a lattice tower, a guyed tower, or mounts on structures such as a water tower or a rooftop, can be used. Additionally, a support can be attached to a vehicle for a mobile communications vehicle. In such examples, the support can be retractable so that the polybeam antennas 420 430, 440, can be raised and lowered. The polybeam antennas 420 430, 440, can be attached to the communications structure 410 via a mount employing bolts or another mechanical type of coupling. In some examples, a u-bolt mount can be used.

The polybeam antennas 420 430, 440, are arranged to provide 360 degree coverage with each one communicating radio frequency signals within a different coverage area. For example, each of the polybeam antennas 420 430, 440, can be configured to provide 120 degree coverage and positioned on the communication structure 410 to cover a different 120 degrees of the 360 degrees.

Each of the polybeam antennas 420 430, 440, includes a lens and a polybeam feed network of signal conveyors that are located within an outer cover that provides protection against the elements. Outer cover 444 of the polybeam antenna 440 is denoted as an example in FIG. 4. The lens of each of the polybeam antennas 420 430, 440, can have a diameter of 18 inches. Lenses having a different diameter can also be used. The lens can be a Luneburg lens or another type of GRIN lens. FIG. 6 provides an example of different sized Luneburg lenses that can be used. Regardless the diameter, the polybeam feed network can be affixed (e.g., printed) to a substrate that is then curved and conforms to the spherical shape of the lens. The angle of each communication beam of the polybeam antennas 420 430, 440, corresponds to a signal conveyor of the polybeam feed network.

The polybeam feed network can include signal isolation features such that the carriers do not interfere with each other when multiple carrier signals that are used. Additionally, carriers enjoy the inherent isolation of feed points due to the physical beam-forming characteristics of the lens. Advantageously, this assists in the co-location of multiple carriers on a single lens of a polybeam antenna.

The polybeam antennas 420 430, 440, can advantageously use the geospatial placement of the signal conveyors that are optimized for maximum gain of each associated radio set that can result in greater data and voice capacity when compared to existing lens antenna technologies. The lens' passive beam-forming does not require electronic beam steering. FIG. 5 provides additional details of a polybeam antenna.

FIG. 5 illustrates a diagram of an example of a polybeam antenna 500 constructed according to the principles of the disclosure. The polybeam antenna 500 includes a lens 510 and a polybeam feed network 520 that is connected to transceivers 530 via communication circuitry 540. For FIG. 5, a Luneburg lens will be used as an example. The transceivers 530 or radios, such as base station radios, are part of radio equipment 550 that can be housed proximate the communications structure that supports the polybeam antenna 500. The communication circuitry 540 includes cabling 545 that can run the length of the communication structure to connect the polybeam feed network 520 to the transceivers 530.

The polybeam feed network 520 includes seven signal conveyors that are patch antennas. The seven patch antennas can connect to the seven transceivers 530 for a 7X bandwidth capacity in a 120° coverage area. The seven patch antennas can also connect to as few as one base station radio in low density areas. Accordingly, carriers can adjust radio capacity based on customer density needs.

The patch antennas of the polybeam feed network can be affixed to a curved substrate, or a substrate that is then curved, that conforms to the spherical shape of the Luneburg lens. One or more of the patch antennas can be affixed on the curved substrate to provide a down tilt when installed. Additionally, the polybeam feed network 520 can be installed with respect to the Luneburg lens 510 to provide a down tilt of the communication beams emanating from the polybeam antenna 500. The geospatial placement of the patch antennas with respect to the Luneburg lens 510 can be optimized for maximum gain of each associated one of the transceivers 530.

The substrate can be, for example, a semiconductor wafer, such as a silicon wafer. The patch antennas provide multiple feed points that can be affixed to a front side of the substrate and a back side of the substrate can be a ground plane.

The Luneburg lens 510 has a spherical shape in which the curved substrate is conformed. The curved substrate can be spaced from the Luneburg lens 510 at a distance and location in order to provide optimum focusing of communication beams for communicating through the Luneburg lens 510. The distance, or gap width, can be determined by an operator of the polybeam antenna 500 and can be based on such factors as size of Luneburg lens, refractive properties of Luneburg lens, frequency of communication, etc.

The Luneburg lens 510 can have a diameter of various sizes. FIG. 6 illustrates examples of various Luneburg lenses of different diameters that can be used in polybeam antennas according to the principles of the disclosure. Four representative sizes and typical ranges of their corresponding transmission frequencies and gain are shown. FIG. 6 illustrates Luneburg lens 600 having a diameter of 18 inches, Luneburg lens 610 having a diameter of 12 inches, Luneburg lens 620 having a diameter of 8 inches, and Luneburg lens 630 having a diameter of 5 inches. Luneburg lenses of greater or lesser diameters, such as a diameter of 35 inches, 72 inches, or 2 inches, can also be used. Regardless the diameter size, the same beam pattern can be transmitted from the various Luneburg lenses providing scalable solutions for various types of installations. Seven signal conveyors are illustrated with each of the Luneburg lenses of FIG. 6 but each one can have a different number depending on, for example, the number of communication beams desired.

FIG. 7 illustrates a flow diagram of an example of a method 700 of communicating carried out according to the principles of the disclosure. The method 700 can be carried out in a wireless communication system having a polybeam geometry, such as in polybeam communications networks 100, 200, or 300 of FIGS. 1, 2, and 3. The method 700 represents a single communication device but can be used with multiple communication devices at the same time. Additionally, the method 700 can be repeated multiple times for each of the communication devices. The method 700 begins in step 705.

In step 710, radio frequency signals from a communication device are captured via one of multiple communication beams. The multiple communication beams can be from one or more polybeam antennas having a lens and a polybeam feed network, such as disclosed herein. Each one of the multiple communication beams has an arc of less than twenty degrees. For example, the multiple communication beams can each have an arc of 17.2 degrees. One or more of the multiple communication beams can have arcs of different sizes, i.e., of different degrees. Radio frequency signals are captured by a communication beam when the communication device is within the coverage area of the communication beam. The polybeam feed network can receive the captured radio frequency signals via the lens.

The communication device has the necessary hardware, software, circuitry, etc. for wireless communication. For example, the communication device includes an antenna and circuitry for transmitting and receiving radio frequency signals. Additionally, the communication device can include processors, memory, user interfaces, etc. for processing data that can be transmitted or received via the multiple communication beams. The data can be, for example, video or audio data. The communication device can be a cell phone, smart phone, a computing pad, a tablet, a laptop, a portable computer, or another type of mobile computing device. The communication device can be compatible with various existing and developing technologies or standards, such as 3G, 4G, and 5G.

In step 720, the captured radio frequency signals are provided to radio equipment. The captured radio frequency signals can be sent from the polybeam feed network to the radio equipment via communication circuitry, such as the communication circuitry 540 of FIG. 5.

In step 730, radio frequency signals received from the radio equipment are transmitted to the communication device via one of the multiple communication beams. The same communication beam used to capture the radio frequency signals from the communication device can be the same communication beans that transmits radio frequency signals to the communication device. For example, the communication device may be within the coverage area of a single communication beam for the capturing and the transmitting. Different communication beams can be used for the capturing and the transmitting when the communication device is moving between the coverage areas of different communication beams. For example, the different communication beams can be interleaved beams from different polybeam antennas, which can be at different antenna sites. Conventional cellular handoff protocols can be used for changing between the different communication beams.

The method 700 continues to step 740 and ends.

A portion of the above-described apparatus, systems or methods, such as some of the functions of the carrier switching units, may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

Each of the aspects of the Summary may have one or more of the following additional elements in combination: Element 1: a second communications structure. Element 2: second transceivers. Element 3: a second polybeam antenna attached to the second communications structure that transmits second communication beams driven by corresponding ones of the second transceivers, having arcs of less than twenty degrees each and defining overlapping territories of coverage. Element 4: wherein at least some of the territories of coverage of the second polybeam antenna are interleaved with at least some of the territories of coverage of the first polybeam antenna. Element 5: further comprising a local antenna attached to the first communications structure that defines a territory of coverage having an arc of at least 60 degrees. Element 6: wherein the local antenna is an omnidirectional antenna. Element 7: wherein the arcs of the first communication beams total about one hundred and twenty degrees. Element 8: wherein a number of the first communication beams is seven. Element 9: wherein the territories of coverage of the first communication beams extend at least ten miles from the first communications structure. Element 10: wherein the first polybeam antenna includes a lens and a polybeam feed network of signal conveyors aligned with the lens to provide the communication beams. Element 11: wherein the lens is a Luneburg lens and has a diameter of eighteen inches. Element 12: further comprising radio equipment coupled to the polybeam feed network via communications circuitry. Element 13: wherein the first communication beams operate at a carrier frequency range of two to eight GHz, and said polybeam antenna has a gain in the range of seventeen to twenty seven. Element 14: further comprising two additional communications structures that each include transceivers and a polybeam antenna attached to the communications structure that transmits communication beams driven by corresponding ones of the transceivers, having arcs of less than twenty degrees each and defining overlapping territories of coverage. Element 15: wherein each of the communications structures includes a local antenna attached to the communications structure that defines a territory of coverage proximate each of the corresponding communications structures. Element 16: wherein the signal conveyors are patch antennas. Element 17: wherein the polybeam feed network is coupled to at least one radio frequency transceivers and the communications beams are driven by the at least one radio frequency transceivers. Element 18: wherein the lens is a Luneburg lens and has a diameter in a range of five inches to eighteen inches. Element 19: wherein the polybeam feed network has at least seven signal conveyors.

What is claimed is:

1. A polybeam communications network, comprising:
a first communications structure;
first transceivers; and
a first polybeam antenna attached to the first communications structure that transmits first communication beams driven by corresponding ones of the first transceivers, having arcs of less than twenty degrees each and defining overlapping territories of coverage.

2. The polybeam communications network as recited in claim 1, further comprising:
a second communications structure;
second transceivers; and
a second polybeam antenna attached to the second communications structure that transmits second communication beams driven by corresponding ones of the second transceivers, having arcs of less than twenty degrees each and defining overlapping territories of coverage.

3. The polybeam communications network as recited in claim 2, wherein at least some of the territories of coverage of the second polybeam antenna are interleaved with at least some of the territories of coverage of the first polybeam antenna.

4. The polybeam communications network as recited in claim 1, further comprising a local antenna attached to the first communications structure that defines a territory of coverage having an arc of at least 60 degrees.

5. The polybeam communications network as recited in claim 4, wherein the local antenna is an omnidirectional antenna.

6. The polybeam communications network as recited in claim 1, wherein the arcs of the first communication beams total about one hundred and twenty degrees.

7. The polybeam communications network as recited in claim 1, wherein a number of the first communication beams is seven.

8. The polybeam communications network as recited in claim 1, wherein the territories of coverage of the first communication beams extend at least ten miles from the first communications structure.

9. The polybeam communications network as recited in claim 1, wherein the first polybeam antenna includes a lens and a polybeam feed network of signal conveyors aligned with the lens to provide the communication beams.

10. The polybeam communications network as recited in claim 9, wherein the lens is a Luneburg lens and has a diameter of eighteen inches.

11. The polybeam communications network as recited in claim 9, further comprising radio equipment coupled to the polybeam feed network via communications circuitry.

12. The polybeam communications network as recited in claim 1, wherein the first communication beams operate at a carrier frequency range of two to eight GHz, and said polybeam antenna has a gain in the range of seventeen to twenty seven.

13. The polybeam communications network as recited in claim 1, further comprising two additional communications structures that each include transceivers and a polybeam antenna attached to the communications structure that transmits communication beams driven by corresponding ones of the transceivers, having arcs of less than twenty degrees each and defining overlapping territories of coverage.

14. The polybeam communications network as recited in claim 13, wherein each of the communications structures includes a local antenna attached to the communications structure that defines a territory of coverage proximate each of the corresponding communications structures.

15. A polybeam antenna, comprising:
a lens; and
a polybeam feed network of signal conveyors aligned with the lens to transmit radio frequency signals via one or more communication beams, wherein each one of the one or more communication beams has an arc of less than twenty degrees and define overlapping territories of coverage.

16. The polybeam antenna as recited in claim 15, wherein the signal conveyors are patch antennas.

17. The polybeam antenna as recited in claim 15, wherein the polybeam feed network is coupled to at least one radio frequency transceivers and the communications beams are driven by the at least one radio frequency transceivers.

18. The polybeam antenna as recited in claim 15, wherein the lens is a Luneburg lens and has a diameter in a range of five inches to eighteen inches.

19. The polybeam antenna as recited in claim 15, wherein the polybeam feed network has at least seven signal conveyors.

20. A method of communicating using a polybeam communications network, comprising:
capturing radio frequency signals from a communication device via one of multiple communication beams, wherein each of the multiple communication beams has an arc of less than twenty degrees;
providing the captured radio frequency signals to radio equipment; and
transmitting radio frequency signals received from the radio equipment to the communication device via one of the multiple communication beams.
